(19) United States
(12) Patent Application Publication
(10) Pub. No.: US 2026/0302089 A1
(43) Pub. Date: Oct. 1, 2026

(54) SOLID ELECTROLYTIC CAPACITOR

(71) Applicant: Panasonic Intellectual Property Management Co., Ltd., Osaka (JP)

(72) Inventors: Yuki Yamanaka, Fukuoka Ken (JP); Kei Hirota, Okayama Ken (JP); Ryoga Hongu, Saga Ken (JP)

(73) Assignee: Panasonic Intellectual Property Management Co., Ltd., Osaka (JP)

(21) Appl. No.: 19/631,447

(22) Filed: Mar. 27, 2026

(30) Foreign Application Priority Data
Mar. 31, 2025 (JP) 2025-059864

(51) Int. Cl. H01G 9/025; H01G 9/15

(52) U.S. Cl. CPC H01G 9/025; H01G 9/15

(57) ABSTRACT

A solid electrolytic capacitor according to the present disclosure includes at least one capacitor element. The capacitor element includes an anode body including a porous part at least at a surface layer, a dielectric layer covering a surface of the anode body, and a solid electrolyte layer covering at least a part of the dielectric layer. The solid electrolyte layer has a first portion filled in voids of the porous part in the anode body having the dielectric layer, and a second portion disposed on an outer surface of the anode body having the dielectric layer. The first portion contains a self-doping conductive polymer, and the second portion containing a non-self-doping conductive polymer.

### CROSS REFERENCE TO RELATED APPLICATION

The present disclosure claims priority with respect to the Japanese Patent Application No. 2025-59864 filed with the Japan Patent Office on Mar. 31, 2025, of which entire content is incorporated herein by reference into the present specification.

### FIELD OF THE INVENTION

The present disclosure relates to a solid electrolytic capacitor.

### BACKGROUND OF THE INVENTION

A solid electrolytic capacitor includes, for example, a capacitor element, and an outer package encapsulating the capacitor element. The capacitor element includes, for example, an anode body, a dielectric layer formed on the surface of the anode body, and a solid electrolyte layer covering at least a part of the dielectric layer. The solid electrolyte layer is formed by, for example, chemical polymerization or electrolytic polymerization, which can also be formed using a processing solution containing a conductive polymer. As the conductive polymer, for example, a self-doping conductive polymer and a non-self-doping conductive polymer are used.

Patent Literature 1 (JP2023-506716A) proposes a “solid electrolytic capacitor, comprising a capacitor element including: an anode body containing tantalum; a dielectric disposed on the anode body; and a solid electrolyte disposed on the dielectric, wherein the solid electrolyte includes an inherently conductive polymer having repeating thiophene units, the capacitor exhibits a dielectric strength of approximately 0.6 volts/nanometer or more, and the capacitor exhibits a charge-discharge capacitance after being subjected to a surge voltage of 3,000 cycles and an initial capacitance before being subjected to the surge voltage, and a ratio of the charge-discharge capacitance to the initial capacitance is approximately 0.75 to 1”.

### BRIEF SUMMARY OF THE INVENTION

Patent Literature 1 discloses that various capacitor characteristics improve depending on the material kind of the solid electrolyte layer, the condition of the dielectric, and other factors. However, there has been a market demand for further improvements in various capacitor characteristics. Moreover, the literature discloses no particular details about the material of the solid electrolyte within the anode body, the pores formed in the anode body, the solid electrolyte formed in the pores, and the solid electrolyte on the outer surface of the anode body.

One aspect of the present invention relates to a solid electrolytic capacitor, including: at least one capacitor element, the capacitor element including an anode body including a porous part at least at a surface layer, a dielectric layer covering a surface of the anode body, and a solid electrolyte layer covering at least a part of the dielectric layer, the solid electrolyte layer having a first portion filled in voids of the porous part in the anode body having the dielectric layer, and a second portion disposed on an outer surface of the anode body having the dielectric layer, the first portion containing a self-doping conductive polymer, the second portion containing a non-self-doping conductive polymer.

According to the present disclosure, an objective is to provide a solid electrolytic capacitor that is excellent in capacitance and withstand voltage performance.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWINGS

FIG. 1 is a schematic sectional view of a solid electrolytic capacitor according to one embodiment of the present disclosure.

FIG. 2 is a schematic enlarged sectional view of a region II in FIG. 1.

### DETAILED DESCRIPTION OF THE INVENTION

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components of capacitors may be adopted. In the present specification, when referring to “a range of a numerical value A to a numerical value B,” the range includes the numerical value A and the numerical value B. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

An electrolytic capacitor according to an embodiment of the present disclosure includes a capacitor element. The capacitor element may be in any form. The capacitor element includes an anode section and a cathode section. The capacitor element includes an anode body including a porous part at least at the surface layer, a dielectric layer covering at least a part of the surface of the anode body, and a solid electrolyte layer covering at least a part of the dielectric layer. The anode body constitutes the anode section. The solid electrolyte layer constitutes the cathode section. The cathode section may include a cathode leading layer.

The solid electrolyte layer has a first portion and a second portion. The first portion is a portion filled in the voids of the porous part of the anode body with a dielectric layer formed on at least a part thereof. On the other hand, the second portion is a portion disposed on the outer surface of the anode body having the dielectric layer (in other words, a portion protruding beyond the principal surface of the anode body).

A part of the first portion may not be filled in the voids of the porous part having the dielectric layer and may protrude from the principal surface of the porous part having the dielectric layer. That is, the first portion may have an inner layer filled in the voids of the porous part having the dielectric layer and an outer layer protruding beyond the principal surface of the porous part having the dielectric layer.

The second portion may be formed like a skin covering the anode body having the dielectric layer. A part of the second portion can be filled in the surface layer portion of the anode body (on the principal surface side of the porous part), of the voids of the porous part having the dielectric layer.

At least the first portion contains a self-doping conductive polymer. The self-doping conductive polymer, which has a small particle size and is easily impregnated into the porous part, can penetrate deep into the pores of the dielectric layer, to cover a larger surface area of the dielectric layer. Therefore, capacity can be drawn from the dielectric layer formed on the anode body. Furthermore, the solid electrolyte layer in the voids of the porous part is a self-doping conductive polymer. This can realize a high withstand voltage performance of the solid electrolytic capacitor.

The porous part may contain a non-self-doping conductive polymer. In this case, the solid electrolyte constituting the first portion filled in the porous part contains the self-doping conductive polymer in a larger amount than the non-self-doping conductive polymer. This can realize a high withstand voltage performance of the solid electrolytic capacitor. The ratio of the volume of the voids filled in the porous part to the volume of the solid electrolyte is preferably 1.0 or more. This can realize a high withstand voltage performance of the solid electrolytic capacitor.

In a solid electrolytic capacitor in which the ratio between the volume of the voids in the porous part and the volume of the solid electrolyte is 1.0 or more, in the porous part, the solid electrolyte is disposed as the first portion in a smaller amount than conventionally. The presence amount of the first portion is designed depending on the required capacity. By limiting the presence amount of the first portion as above, the reduction in withstand voltage characteristics due to deterioration of the solid electrolyte is suppressed. The ratio between the volume of the voids in the porous part and the volume of the solid electrolyte may be 1.3 or more, may be 1.5 or more, may be 1.8 or more, and may be 2.0 or more. Furthermore, from the viewpoint of ensuring the required capacity, the ratio between the volume of the voids filled in the porous part and the volume of the solid electrolyte is, for example, preferably 5 or less, may be 4 or less, and may be 3 or less.

The ratio between the volume of the voids in the porous part and the volume of the solid electrolyte can be determined by the following method. First, the solid electrolytic capacitor or its capacitor element is embedded in an acrylic resin, and then, in the embedded solid electrolytic capacitor or capacitor element, an element cross-section passing approximately through the center of the anode body is formed. If the anode section includes an anode body and an anode wire partially embedded in the anode body, an element cross-section may be formed so as to intersect the anode wire. The element cross-section may be formed in parallel with any one of the faces of the electrolytic capacitor. For example, when the capacitor element is a rectangular prism, the element cross-section may be formed at the central portion in the longitudinal direction.

The element cross-section is processed by grinding with a cross-section polisher (CP). Subsequently, an observation area having an area of 3000 μm² is defined. The observation area is defined on the surface layer side of the anode body. For example, the observation area may be defined as a rectangular region including a point O on the outer surface of the anode body, which is the point farthest from the center of the element cross-section. The point O is located at the tip of a corner of the rectangular region. For example, an observation area within 100 μm of the outer edge of the anode body having the dielectric layer is defined.

Next, a backscattered electron image and a secondary electron image of the defined observation area are photographed using a scanning electron microscope (SEM). By multi-level binarizing the photographed backscattered electron image and secondary electron image using a discriminant analysis method, and combining them, the metal part in the anode body, the dielectric layer, the solid electrolyte, the voids, etc. can be identified, and the distribution state of the metal part, the dielectric layer, the solid electrolyte, and the voids can be measured.

For example, when the image of the observation area is divided into a first image part of the anode body having the dielectric layer and a second image part except the first image part, the second image part indicates the distribution state of the voids (including portions filled with the solid electrolyte) in the anode body having the dielectric layer. The second image part can be divided into a first portion filled with the solid electrolyte and a void portion not filled with the solid electrolyte. Thus, the ratio between the volume of the voids to the volume of the solid electrolyte in the porous part can be determined. The ratio between the volume of the voids to the volume of the solid electrolyte in the porous part is measured in three or more different observation areas, and the measured values are averaged.

The thickness of the solid electrolyte layer in the second portion is preferably set to 1 μm or more and 200 μm or less.

As preferable embodiments of the solid electrolyte layer according to the present disclosure, the following embodiments can be exemplified.

### First Embodiment

A solid electrolytic capacitor, comprising:
at least one capacitor element, the capacitor element including
   an anode body including a porous part at least at a surface layer,
   a dielectric layer covering a surface of the anode body, and
   a solid electrolyte layer covering at least a part of the dielectric layer,
the solid electrolyte layer having,
   a first portion filled in voids of the porous part in the anode body having the dielectric layer, and a second portion disposed on an outer surface of the anode body having the dielectric layer,
   the first portion containing a self-doping conductive polymer, the second portion containing a non-self-doping conductive polymer.

### Second Embodiment

A solid electrolytic capacitor, comprising:
at least one capacitor element, the capacitor element including
   an anode body including a porous part at least at a surface layer,
   a dielectric layer covering a surface of the anode body, and
   a solid electrolyte layer covering at least a part of the dielectric layer,
the solid electrolyte layer having,
   a first portion filled in voids of the porous part in the anode body having the dielectric layer, and a second portion disposed on an outer surface of the anode body having the dielectric layer,
   the first portion containing a self-doping conductive polymer, the second portion containing a non-self-doping conductive polymer,
wherein a ratio of a volume of the voids in the porous part to a volume of the solid electrolyte is 1.0 or more.

### Third Embodiment

The solid electrolytic capacitor comprising:
at least one capacitor element, the capacitor element including
   an anode body including a porous part at least at a surface layer,
   a dielectric layer covering a surface of the anode body, and
   a solid electrolyte layer covering at least a part of the dielectric layer,
the solid electrolyte layer having,
   a first portion filled in voids of the porous part in the anode body having the dielectric layer, and a second portion disposed on an outer surface of the anode body having the dielectric layer,
   the first portion containing a self-doping conductive polymer, the second portion containing a non-self-doping conductive polymer,
wherein a thickness of the solid electrolyte layer in the second portion is 1 μm or more and 200 μm or less.

### Fourth Embodiment

The solid electrolytic capacitor comprising:
at least one capacitor element, the capacitor element including
   an anode body including a porous part at least at a surface layer,
   a dielectric layer covering a surface of the anode body, and
   a solid electrolyte layer covering at least a part of the dielectric layer,
the solid electrolyte layer having,
   a first portion filled in voids of the porous part in the anode body having the dielectric layer, and a second portion disposed on an outer surface of the anode body having the dielectric layer,
   the first portion containing a self-doping conductive polymer, the second portion containing a non-self-doping conductive polymer,
wherein the second portion further contains the self-doping conductive polymer, and
the self-doping conductive polymer in the second portion is disposed between the dielectric layer and the non-self-doping conductive polymer.

The configuration of an example of the electrolytic capacitor according to the present disclosure will be more specifically described below.

### [Solid Electrolytic Capacitor]

The capacitor element included in the solid electrolytic capacitor includes an anode section and a cathode section. The cathode section includes a solid electrolyte layer. The solid electrolytic capacitor and the capacitor element according to the present disclosure are mainly characterized by the solid electrolyte layer, and other components are not particularly limited. For each component, components used in known solid electrolytic capacitors may be adopted.

### (Capacitor Element)

The anode section of the capacitor element includes an anode body. A dielectric layer is formed on at least a part of the surface of the anode body. The cathode section is formed on at least a part of the surface of the dielectric layer.

### (Anode Body)

The anode body is formed from a conductive material. The anode body may be a sheet-like anode foil, and may be a molded body or a sintered body of metal particles.

The conductive material constituting the anode body may include a valve metal, an alloy containing a valve metal, or a compound containing a valve metal. The anode body may include these materials singly or in combination of two or more kinds. As the valve metal, for example, aluminum, tantalum, niobium, and titanium are preferred.

The anode body has a porous part at least at its surface layer. The anode body has many fine voids in the porous part. By such a porous part, the anode body can have fine irregularities on its surface.

An anode body having a porous part at its surface layer can be obtained by, for example, roughening the surface of a base material, such as a sheet-like (e.g., foil-like or plate-like) base material, containing a valve metal. Roughening may be performed by, for example, an etching treatment, such as electrolytic etching and chemical etching. Such an anode body (anode foil) has, for example, a core and porous parts formed integrally with the core on both surfaces of the core.

The anode body may be a sintered body or a molded body of particles containing a valve metal. The molded body and the sintered body are porous bodies and may be rectangular prismatic, cubic, or in a shape similar thereto. The sintered body may be, for example, a sintered body of particles containing tantalum.

The anode body may have an electrode leading part (which may be referred to as an anode leading part) including a first end, and a cathode forming part including a second end opposite the first end. The cathode section including the solid electrolyte layer is formed on the surface of the cathode forming part of the anode body. The anode leading part is used, for example, for electrical connection with an external electrode on the anode side. An anode lead terminal may be connected to the anode leading part.

### (Anode Wire)

When the anode body is a porous sintered body or a porous molded body, the anode section may include an anode wire. The anode wire may be a metal wire. Examples of the material of the anode wire include the aforementioned valve metals, copper, and copper alloy. A part of the anode wire is embedded in the anode body, and the rest part of the anode wire protrudes outward from the end surface of the anode body. The end of the anode wire protruding outward corresponds to the first end, and the end of the anode body opposite the first end corresponds to the second end.

### (Dielectric Layer)

The dielectric layer is formed so as to cover at least a part of the surface of the anode body or the porous part. The dielectric layer can be formed using a known method. The dielectric layer may be formed by oxidizing the valve metal on the surface of the anode body or the porous part by chemical conversion treatment and the like. The dielectric layer has fine irregularities conforming to the surface profile of the porous part.

The dielectric layer contains an oxide of the valve metal. For example, when tantalum is used as the valve metal, the dielectric layer contains tantalum oxide such as Ta₂O₅. When aluminum is used as the valve metal, the dielectric layer contains aluminum oxide such as Al₂O₃. Note that the dielectric layer is not limited to these examples, and may be anything that functions as a dielectric.

### (Cathode Section)

The cathode section includes at least a solid electrolyte layer covering at least a part of the dielectric layer. The solid electrolyte layer is formed via the dielectric layer, at a part of the anode body on the second end side (in other words, the cathode forming part). The cathode section usually includes a solid electrolyte layer covering at least a part of the dielectric layer, and a cathode leading layer covering at least a part of the solid electrolyte layer.

### (Solid Electrolyte Layer)

In the capacitor element, the solid electrolyte layer is formed so as to cover at least a part of the dielectric layer. The solid electrolyte layer has a first portion filled in the voids of the porous part, and a second portion protruding beyond the principal surface of the anode body having the dielectric layer. The first portion contains a self-doping conductive polymer as described above, and also contains an antioxidant. The first portion may further contain a non-self-doping conductive polymer.

### (Self-Doping Conductive Polymer)

The self-doping conductive polymer has, for example, a backbone of a conjugated polymer and a functional group, such as an anionic group, that functions as a dopant bonded directly or indirectly to the backbone via a covalently bond.

Examples of the anionic group include a sulfo group, a carboxy group, a phosphate group, and a phosphonate group. The self-doping conductive polymer may contain one kind or two or more kinds of the anionic group. From the viewpoint of ensuring higher conductivity of the self-doping conductive polymer, the self-doping conductive polymer may contain at least a sulfo group.

The anionic group of the self-doping conductive polymer may be included in any form of an anion, an acid, an ester, a salt, etc., and may be included in a form that has been interacted with or formed into a composite with a component contained in the solid electrolyte layer. In the present specification, including all of these forms, it is simply referred to as an anionic group.

The conjugated polymer constituting the backbone of the self-doping conductive polymer may be, for example, a polymer whose backbone is a x-conjugated polymer, such as polypyrrole, polythiophene, polyaniline, polyfuran, polyacetylene, polyphenylene, polyphenylene vinylene, polyacene, and polythiophene vinylene. The above polymer contains at least one kind of monomer that constitutes the backbone. The above polymer also include a homopolymer, a copolymer of two or more kinds of monomers, and a derivative thereof (e.g., a substituted derivative thereof having a substituent). For example, polythiophene includes poly(3,4-ethylenedioxythiophene), and the like. The self-doping conductive polymer has an anionic group on the backbone of these conjugated polymers. The anionic group may be introduced directly on the backbone of the conjugated polymer, and may be introduced via a linking group. The linking group is preferably a polyvalent group (divalent group) including an alkylene group. Examples of the linking group include: an aliphatic polyvalent group (divalent group, etc.), such as an alkylene group; and a —R¹—X—R²— group, where X is oxygen or sulfur element, and R¹ and R² are the same or different, and an alkylene group. The number of carbon atoms in each of the alkylene group contained in the linking group is, for example, 1 to 10, and may be 1 to 6. The alkylene group may be linear or branched. The linking group may contain, for example, at least an alkylene group having 2 or more carbon atoms. The number of carbon atoms in such an alkylene group may be 2 (or 3) to 10, and may be 2 (or 3) to 6. For example, R¹ may be an alkylene group having 1 to 6 carbon atoms, and R² may be an alkylene group having 2 (or 3) to 10 carbon atoms. The linking group, however, is not limited thereto.

The conjugated polymer constituting the backbone of the self-doping conductive polymer may be polypyrrole, polythiophene, or polyaniline. From the viewpoint of achieving high conductivity, a preferred self-doping conductive polymer is a polymer having a backbone of a conjugated polymer including a repeating structure of a monomer unit corresponding to a thiophene compound, and an anionic group introduced on the backbone.

As the thiophene compound, a compound that has a thiophene ring and is capable of forming a repeating structure of a monomer unit corresponding thereto can be used. The thiophene compound can form a repeating structure of a monomer unit in which the thiophene rings are linked at the 2- and 5-positions.

The thiophene compound may have a substituent at least at one of the 3- and 4-positions of the thiophene ring. The substituent at the 3-position and the substituent at the 4-position may be linked to each other, forming a ring condensed to the thiophene ring. Examples of the thiophene compound include: a thiophene that may have a substituent at least at one of the 3- and 4-positions; and an alkylenedioxythiophene compound (e.g., a C₂₋₄ alkylenedioxythiophene compound, such as ethylenedioxythiophene compound). The alkylenedioxythiophene compound also includes a compound having a substituent in the place of the alkylene group.

As the substituent, an alkyl group (e.g., a C₁₋₄ alkyl group, such as methyl and ethyl), an alkoxy group (e.g., a C₁₋₄ alkoxy group, such as methoxy and ethoxy), a hydroxy group, a hydroxyalkyl group (e.g., a hydroxy C₁₋₄ alkyl group, such as hydroxymethyl), and the like are preferred, but not limited thereto. When the thiophene compound has two or more substituents, the respective substituents may be the same or different. The thiophene ring (in the alkylenedioxythiophene ring, at least one of the thiophene ring and the alkylene group) may have, as a substituent, the aforementioned anionic group or a group containing the anionic group (e.g., a sulfoalkyl group, etc.).

The self-doping conductive polymer may have a backbone of a conjugated polymer, such as PEDOT, including a repeating structure of a monomer unit corresponding to at least a 3,4-ethylenedioxythiophene compound, such as 3,4-ethylenedioxythiophene (EDOT). The backbone of a conjugated polymer including a repeating structure of a monomer unit corresponding to at least EDOT may contain only a monomer unit corresponding to EDOT, and may contain, in addition to the above monomer unit, a monomer unit corresponding to a thiophene compound other than EDOT.

The below shows an example of the monomer unit of the self-doping conductive polymer.

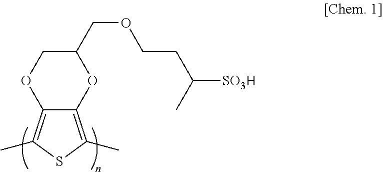

The weight average molecular weight (Mw) of the self-doping conductive polymer may be 1,000 or more and 1,000,000 or less, and may be 1,000 or more and 50,000 or less.

In the present specification, the weight average molecular weight (Mw) is a value in terms of polystyrene as measured by gel permeation chromatography (GPC). In the GPC, usually, a polystyrene gel column, and water/methanol (volume ratio 8/2) as a mobile phase are used for measurement.

### (Non-Self-Doping Conductive Polymer)

The non-self-doping conductive polymer includes, for example, a non-self-doping conjugated polymer (e.g., a conjugated polymer having no anionic group) and a dopant.

The conjugated polymer may be a conjugated polymer, such as a x-conjugated polymer, as exemplified for the conjugated polymer constituting the backbone of the self-doping conductive polymer. The conjugated polymer may be used singly or in combination of two or more kinds. From the viewpoint of ensuring initial high capacitance and withstand voltage performance, and other properties such as high heat resistance, a non-self-doping conjugated polymer including a repeating structure of a monomer unit of a thiophene compound may also be used. The thiophene compound corresponding to the monomer unit of the non-self-doping conjugated polymer may be a thiophene compound as exemplified for the self-doping conductive polymer. The non-self-doping conjugated polymer may include a conjugated polymer (PEDOT, etc.) including a repeating structure of a monomer unit corresponding to at least 3,4-ethylenedioxythiophene compound (EDOT, etc.). The conjugated polymer including a repeating structure unit of a monomer unit corresponding to at least EDOT may contain only a monomer unit corresponding to EDOT, or may contain, in addition to the above monomer unit, a monomer unit corresponding to a thiophene compound other than EDOT.

The dopant may be at least one selected from the group consisting of anions and polyanions (e.g., polymer anions). Examples of the anions include sulfate ions, nitrate ions, phosphate ions, borate ions, organic sulfonate ions, and carboxylate ions. As the dopant that generates sulfonate ions, for example, p-toluenesulfonic acid, naphthalenesulfonic acid, and the like are exemplified. From the viewpoint of obtaining higher heat resistance and reliability, and ensuring hither withstand voltage performance, polymer anions may be used. As the polymer anions having a sulfo group, a polymer-type polysulfonic acid is exemplified. Specific examples of the polymer anions include polyvinyl sulfonic acid, polystyrene sulfonic acid (PSS (including its copolymer and its substituted derivative having a substituent), polyallylsulfonic acid, polyacrylic sulfonic acid, polymethacrylic sulfonic acid, poly(2-acrylamido-2-methylpropanesulfonic acid), polyisoprene sulfonic acid, polyester sulfonic acid (aromatic polyester sulfonic acid, etc.), and phenolsulfonic acid novolac resin. However, the dopant is not limited to these specific examples. The dopant may be used singly or in combination of two or more kinds.

In the non-self-doping conductive polymer, the amount of the dopant, relative to 100 parts by mass of the conjugated polymer, may be 10 parts by mass or more and 1000 parts by mass or less, and may be 20 parts by mass or more and 500 parts by mass or less.

### (Method for Forming Solid Electrolyte Layer)

A step of forming a solid electrolyte layer covering at least a part of the dielectric layer includes, for example, a first step of forming a first portion, and a second step of forming a second portion. A step of performing an optional treatment may be further included between the first step and the second step.

### (First Step of Forming First Portion)

The first step includes a step of forming a first layer containing a self-doping conductive polymer.

### (Step of Forming First Layer)

In the step of forming a first layer, for example, the first layer may be formed using a processing solution (first processing solution) containing a self-doping conductive polymer. Specifically, a first processing solution containing a self-doping conductive polymer is applied to the dielectric layer, to form a first layer. The first processing solution may be dried after applied to the dielectric layer. The applying of the first processing solution to the dielectric layer and the drying may be repeated twice or more times, as necessary.

The first processing solution contains, for example, a self-doping conductive polymer and a liquid medium. The first processing solution may contain one kind or two or more kinds of the self-doping conductive polymer. The liquid medium is, for example, a medium that is liquid at room temperature (e.g., 20° C. or higher and 35° C. or lower). Examples of the liquid media include water, an organic solvent, or a mixture thereof. In particular, water is preferably used.

The first processing solution may be a dispersion in which particles of the self-doping conductive polymer are dispersed in the liquid medium, and may be a solution in which the self-doping conductive polymer is dissolved in the liquid medium. In the self-doping conductive polymer, the polymer chain is relatively flexible, and the position of the functional group such as anionic group is random. Moreover, in the self-doping conductive polymer, the orientation of the polymer chain is low, and the crystallinity is low. Therefore, as compared to the non-self-doping conductive polymer, the self-doping conductive polymer is apt to dissolve in the liquid medium or disperse in the form of fine particles. Therefore, the first processing solution has a relatively low viscosity, and can be easily impregnated into the voids in the porous part with high permeability.

The concentration of the self-doping conductive polymer in the first processing solution may be 0.5 mass % or more and 5 mass % or less, and may be 1 mass % or more and 3 mass % or less.

### (Step of Forming Second Layer)

In the step of forming a second layer, for example, the second layer may be formed using a processing solution (second processing solution) containing a non-self-doping conductive polymer. Specifically, a second processing solution containing a self-doping conductive polymer is applied to the dielectric layer, to form a second layer. The second processing solution may be dried after applied to the dielectric layer. The applying of the second processing solution to the dielectric layer and the drying may be repeated twice or more times, as necessary.

The second processing solution contains, for example, a non-self-doping conductive polymer and a liquid medium. The second processing solution may be a dispersion in which particles of the non-self-doping conductive polymer are dispersed in the liquid medium. Examples of the liquid media include water, an organic solvent, or a mixture thereof. In particular, water is preferably used.

The concentration of the non-self-doping conductive polymer in the second processing solution may be 0.5 mass % or more and 5 mass % or less, and may be 1 mass % or more and 3 mass % or less.

In the step of forming a second layer, the second layer may be formed using a processing solution (second processing solution) containing a monomer of the non-self-doping conductive polymer, an oxidizing agent serving as a dopant, and a liquid solvent. Specifically, the capacitor element may be immersed in the second processing solution, and then dried. The applying of the second processing solution to the dielectric layer and the drying may be repeated twice or more times, as necessary.

### (Second Step of Forming Second Portion)

In the second step, for example, the second portion covering at least a part of the first portion is formed so as to extend beyond the principal surface of the anode body having the dielectric layer, using a processing solution (second processing solution) containing a non-self-doping conductive polymer. Specifically, the second portion is formed by applying the second processing solution containing a non-self-doping conductive polymer to the dielectric layer. The second processing solution may be dried after applied to the first portion.

The second processing solution may contain, for example, a non-self-doping conductive polymer and a liquid medium. The second processing solution may contain one kind or two or more kinds of the self-doping conductive polymer, in addition to the non-self-doping conductive polymer. Examples of the liquid media include water, an organic solvent, or a mixture thereof. In particular, water is preferably used.

The concentration of the non-self-doping conductive polymer in the second processing solution may be 0.5 mass % or more and 5 mass % or less, and may be 1 mass % or more and 3 mass % or less. The non-self-doping conductive polymer, which has a large particle diameter, hardly enters the pores in the porous part of the anode body, and is likely to form a film of the non-self-doping conductive polymer like a skin on the outside of the porous part.

In the second step, the second portion covering at least a part of the first portion may be formed so as to extend beyond the principal surface of the anode body having the dielectric layer, using a processing solution (second processing solution) containing a monomer of the non-self-doping conductive polymer, an oxidizing agent serving as a dopant, and a liquid solvent. Specifically, the capacitor element may be immersed in the second processing solution, and then dried. The applying of the second processing solution to the dielectric layer and the drying may be repeated twice or more times, as necessary. By increasing the viscosity of the second processing solution, the non-self-doping conductive polymer hardly enters the pores in the porous part of the anode body, and is likely to form a film of the non-self-doping conductive polymer like a skin on the outside of the porous part.

### (Cathode Leading Layer)

The cathode leading layer may include, for example, at least a first leading layer that contacts the solid electrolyte layer and covers at least a part of the solid electrolyte layer. The cathode leading layer may include a first leading layer and a second leading layer covering at least a part of the first leading layer.

The first leading layer may be, for example, a layer containing conductive particles, a metal foil, and the like. The conductive particles may be, for example, at least one selected from a conductive carbon and a metal powder. The cathode section (more specifically, the cathode leading layer) may include a layer containing a metal powder (e.g., a metal particle-containing layer). The cathode leading layer may be constituted of, for example, a layer containing a conductive carbon (carbon layer) serving as the first leading layer, and a layer containing a metal powder (e.g., metal particle-containing layer) or a metal foil serving as the second leading layer.

When the cathode leading layer includes a metal foil or a metal particle-containing layer, the entire cathode leading layer may be constituted of a metal foil or a metal particle-containing layer. At least one of the first leading layer and the second leading layer may be constituted of a metal particle-containing layer.

Examples of the conductive carbon include graphite, such as synthetic graphite and natural graphite.

A layer containing a metal powder serving as the second leading layer can be formed by, for example, laminating a composition containing a metal powder onto the surface of the first leading layer. Such a second leading layer may be, for example, a metal particle-containing layer formed using a paste including a metal powder and a resin binder. The resin binder may be a thermoplastic resin, but is preferably a thermosetting resin, such as an imide resin and an epoxy resin. From the viewpoint of obtaining high conductivity of the second leading layer, silver-containing particles may be used as the metal powder. Examples of the silver-containing particles include silver particles and silver alloy particles. The second leading layer may contain the silver-containing particles singly or in combination of two or more kinds. The silver particles may contain a small amount of impurities.

When using a metal foil as the first leading layer, any kind of metal may be used. For the metal foil, a valve metal, such as aluminum, tantalum, and niobium, or an alloy containing a valve metal is preferably used. The surface of the metal foil may be roughened as necessary. The surface of the metal foil may be provided with a chemical conversion film, and may be provided with a coating of a metal (dissimilar metal) different from the metal constituting the metal foil or of a non-metal. Examples of the dissimilar metal and the non-metal include metals, such as titanium, and non-metals, such as carbon (e.g., conductive carbon).

The aforementioned coating of a dissimilar metal or a non-metal (e.g., conductive carbon) may be used as the first lading layer, and the aforementioned metal foil may be used as the second lading layer.

The cathode leading layer is formed by a known method according to its layer configuration. For example, when the cathode leading layer includes a metal foil as the first lading layer or the second leading layer, the first leading layer or the second leading layer is formed by laminating a metal foil so as to cover at least a part of the solid electrolyte layer or the first leading layer. The first leading layer containing conductive particles is formed by, for example, applying a conductive paste or liquid dispersion containing conductive particles and, as necessary, a resin binder (e.g., a water-soluble resin, a curable resin), onto a surface of the solid electrolyte layer. The second leading layer containing a metal powder is formed by, for example, applying a paste containing a metal powder and a resin binder onto a surface of the first lading layer. In the process of forming a cathode leading layer, drying, heating, and other treatments may be performed as necessary.

The capacitor element is encapsulated with an outer package. For example, with the capacitor element and the material resin of the outer package (e.g., uncured thermosetting resin and filler) placed in a mold, the capacitor element may be encapsulated in the resin outer package by transfer molding, compression molding, or other techniques. At this time, the other end of the anode lead terminal connected to the anode lead and the other end of the cathode lead terminal, which are drawn out from the capacitor element, are each partially exposed from the mold. The lead may be in the form of a wire, and may be in the form of a frame (e.g., lead frame).

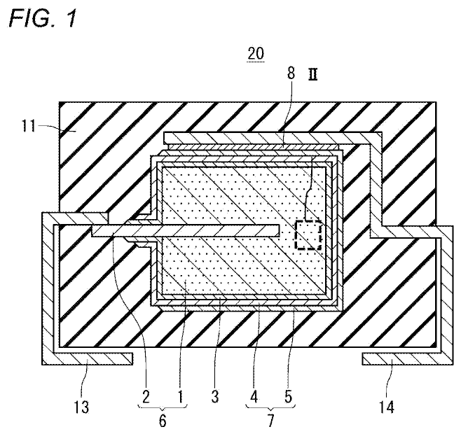

FIG. 1 is a schematic sectional view of a solid electrolytic capacitor according to one embodiment of the present disclosure. A solid electrolytic capacitor 20 includes a capacitor element 10 including an anode section 6 and a cathode section 7, an outer package 11 encapsulating the capacitor element 10, an anode lead frame 13 electrically connected to the anode section 6, and a cathode lead frame 14 electrically connected to the cathode section 7.

The anode section 6 has an anode body 1 and an anode wire 2. A part of the anode wire 2 is embedded in the anode body 1, and the rest part thereof is extended outward from the outer surface of the anode body 1. A part of the first portion of the anode lead frame 13 is joined to the extended part of the anode wire 2 by welding or other techniques, and electrically connected thereto.

A dielectric layer 3 is formed on the surface of the anode body 1. The cathode section 7 includes a solid electrolyte layer 4 covering at least a part of the dielectric layer 3, and a cathode leading layer 5 covering at least a part of the surface of the solid electrolyte layer 4. The cathode leading layer 5 includes a carbon layer formed so as to cover at least a part of the surface of the solid electrolyte layer 4, and a metal particle-containing layer formed so as to cover at least a part of the carbon layer. A part of the first portion of the cathode lead frame 14 is bonded to the cathode leading layer 5 via a conductive adhesive layer 8, and electrically connected thereto.

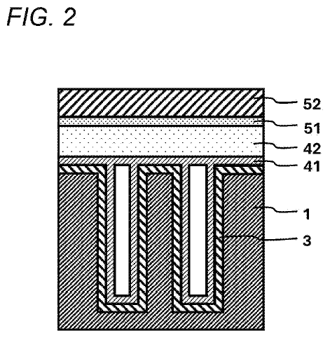

FIG. 2 is a schematic enlarged sectional view of the region II in FIG. 1. The dielectric layer 3 is formed on the surface of the anode body 1. The solid electrolyte layer includes a first portion 41 filled in the voids of the porous part, and a second portion 42 disposed on the outer surface of the anode body 1. A part of the first portion 41 is formed between the dielectric layer 3 on the outer surface of the anode body 1 and the second portion 42. A carbon layer 51 is disposed on the upper surface of the second portion 42, and a silver paste layer 52 is disposed on the upper surface of the carbon layer 51.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

The solid electrolytic capacitor according to the present disclosure can be used in applications for which excellent capacitance and withstand voltage performance are required.

### REFERENCE NUMERALS

20: solid electrolytic capacitor
   10: capacitor element
   1: anode body
   2: anode wire
   3: dielectric layer
   4: solid electrolyte layer
   5: cathode leading layer
   6: anode section
   7: cathode section
   8: conductive adhesive layer
   11: outer package
   13: anode lead frame
   14: cathode lead frame
      41: first portion
      42: second portion
      51: carbon layer
      52: silver paste layer

What is claimed is:

1. A solid electrolytic capacitor, comprising:
at least one capacitor element, the capacitor element including
an anode body including a porous part at least at a surface layer,
a dielectric layer covering a surface of the anode body, and
a solid electrolyte layer covering at least a part of the dielectric layer,
the solid electrolyte layer having
a first portion filled in voids of the porous part in the anode body having the dielectric layer, and a second portion disposed on an outer surface of the anode body having the dielectric layer,
the first portion containing a self-doping conductive polymer, the second portion containing a non-self-doping conductive polymer.

2. The solid electrolytic capacitor according to claim 1, wherein a ratio of a volume of the voids in the porous part to a volume of the solid electrolyte is 1.0 or more.

3. The solid electrolytic capacitor according to claim 2, wherein a thickness of the solid electrolyte layer in the second portion is 1 μm or more and 200 μm or less.

4. The solid electrolytic capacitor according to claim 3, wherein
the second portion further contains the self-doping conductive polymer, and
the self-doping conductive polymer in the second portion is disposed between the dielectric layer and the non-self-doping conductive polymer.
